(19) United States
(12) Patent Application Publication
(10) Pub. No.: US 2017/0161791 A1
(43) Pub. Date: Jun. 8, 2017

(54) IDENTIFYING ACCOUNT SEGMENTS BASED ON CONTENT IMPRESSIONS AND PURCHASE DECISIONS

(71) Applicant: eBay Inc., San Jose, CA (US)

(72) Inventors: Saad Zaheer, San Mateo, CA (US); Brian Brownie, San Jose, CA (US); Joseph Quinn, San Jose, CA (US); Jinsub Hong, San Jose, CA (US)

(21) Appl. No.: 15/095,527

(22) Filed: Apr. 11, 2016

Related U.S. Application Data
(60) Provisional application No. 62/262,447, filed on Dec. 3, 2015.

(51) Int. Cl. G06Q 30/02

(52) U.S. Cl. CPC G06Q 30/0273; G06Q 30/0244

(57) ABSTRACT

According to various embodiments, an Ad Price Optimizing Engine receives a plurality of data packets from a remote content provider(s). Each of the data packets includes a content field identifying a previously transmitted content item and a price field. The price field identifies an impression cost of the previously transmitted content item. The CPO Engine accesses a member account data store related to each member account. The member account data store includes a purchase history and a plurality of received content item identifiers. Each received content item identifier indicates a respective content item displayed to a corresponding member account. The CPO Engine instantiates a content-pricing data structure for the corresponding member account to include a linkage between the purchase history and each impression cost of any previously transmitted content item displayed to the corresponding member account.

### CROSS-REFERENCE TO RELATED APPLICATIONS

This application claims the benefit of priority to U.S. Provisional Patent Application entitled “Identifying Account Segments Based on Advertisement Impressions and Purchase Decisions,” Ser. No. 62/262,447, filed Dec. 3, 2015, which is hereby incorporated herein by reference in its entirety.

### TECHNICAL FIELD

The present application relates generally to the technical field of determining relationships between data fields in data packets and respective member accounts and optimizing pricing for display of content on a per-account basis.

### BACKGROUND

Typical electronic commerce (“e-commerce) sites provide users (e.g., sellers) with computer-implemented services for selling goods or services through, for example, a website. For example, a seller may submit information regarding a good or service to the e-commerce site through a web-based interface. Upon receiving the information regarding the good or service, the e-commerce site may store the information as a listing that offers the good or service for sale. Other users (e.g., buyers) may interface with the e-commerce site through a search interface to find goods or services to purchase.

### BRIEF DESCRIPTION OF THE DRAWINGS

The present invention is illustrated by way of example, and not by way of limitation, in the figures of the accompanying drawings in which:

FIG. 1 is a network diagram depicting a publication system, according to one embodiment, having a client-server architecture configured for exchanging data over a network;

FIG. 2 is a block diagram illustrating components of an CPO Engine application, according to some example embodiments;

FIG. 3 is a block diagram of the CPO Engine de-anonymizing advertiser metric data, according to some example embodiments;

FIG. 4 is a block diagram illustrating account transaction data, according to some example embodiments;

FIG. 5 is a block diagram of the CPO Engine identifying a plurality of segment of member accounts, according to some example embodiments;

FIG. 6 is a flow diagram illustrating an example of method operations for determining a price for a future online ad impression served to all accounts within respective segments, according to some example embodiments;

FIG. 7 is a flow diagram illustrating an example of method operations for determining a price for displaying online content to each member account assigned to a particular segment of member accounts, according to some example embodiments.

FIG. 8 is a block diagram illustrating an example of a software architecture that may be installed on a machine, according to some example embodiments.

FIG. 9 illustrates a diagrammatic representation of a machine in the form of a computer system within which a set of instructions may be executed for causing the machine to perform any one or more of the methodologies discussed herein, according to an example embodiment.

The headings provided herein are merely for convenience and do not necessarily affect the scope or meaning of the terms used.

### DETAILED DESCRIPTION

Example methods and systems directed to a Content Price Optimizing Engine are described. In the following description, for purposes of explanation, numerous specific details are set forth in order to provide a thorough understanding of example embodiments. It will be evident, however, to one skilled in the art that the present invention may be practiced without these specific details.

A system, a machine-readable storage medium storing instructions, and a computer-implemented method are described herein for a Content Price Optimizing Engine (“CPO Engine”) that receives a plurality of data packets from at least one remote content provider. Each of the data packets includes a content field identifying a previously transmitted content item to a publication system and a price field. The price field in each received data packet identifies an impression cost of the previously transmitted content item identified by that data packet.

For each member account of a plurality of member accounts of the publication system, the CPO Engine accesses an member account data store related to each member account. The member account data store includes a purchase history of a corresponding member account and a plurality of received content item identifiers. Each received content item identifier indicates a respective content item from the at least one remote content provider displayed to the corresponding member account. The CPO Engine instantiates a content-pricing data structure for the corresponding member account to include a linkage between the purchase history of the corresponding member account and each impression cost of any previously transmitted content item from the at least one remote content displayed to the corresponding member account.

In various exemplary embodiments, the content items sent to the publication system can be a plurality of different online advertisements from one or more 3^{rd} Party advertiser sources. However, it is understood that various embodiments described herein are not limited to online advertisements and can include any type of online content (such as video, text, images, social network data, etc.) The 3^{rd} Party advertiser sources send the publication system advertiser metrics, which includes identifiers of online advertisements sent to the publication system for display to respective member accounts. The advertiser metrics also include the impression cost of each online advertisement.

The member account data store can be publisher data from the publication system, which includes purchase histories of respective member accounts and identifiers of online advertisements displayed to the member accounts. The CPO Engine determines a score based on an advertiser metrics and publisher data for each member account in a plurality of member accounts of the publication system. The advertiser metric is based on online advertisement (hereinafter “online ad”) impressions served to a respective member account. The publisher data indicates publication system activity of that same respective member account. The CPO Engine identifies a plurality of segments based on the scores. The CPO Engine determines a price for a future online ad impression served to all member accounts within each segment.

In one embodiment, the CPO Engine infers a respective member account's value to 3^{rd} Party advertiser sources in terms of how many times, or for what price, various 3^{rd} Party advertiser sources have previously served online ads to that respective member account and the actual purchase decisions made by the respective member account. In conventional systems, such data from 3^{rd} Party advertiser sources and member account purchase decisions are disparate from each other and are not explicitly linked. In contrast to conventional systems, the CPO Engine links such 3^{rd} Party advertiser data and purchase decisions on a per-member account basis in order to determine whether a price to serve an online ad to a segment of similar member accounts should be auctioned off to 3^{rd} Party advertiser sources at an increased (or decreased) price. According to an example embodiment, the CPO Engine determines that a cost for serving online ads to a segment of highly-engaged member accounts should be auctioned at a new increased price. As the CPO Engine receives actual bids from one or more 3^{rd} Party advertiser sources, the auction price can be adjusted—using the new increased price as a baseline price—so as to reflect the actual, real-time market demand for serving an online ad(s) to a particular segment of member accounts.

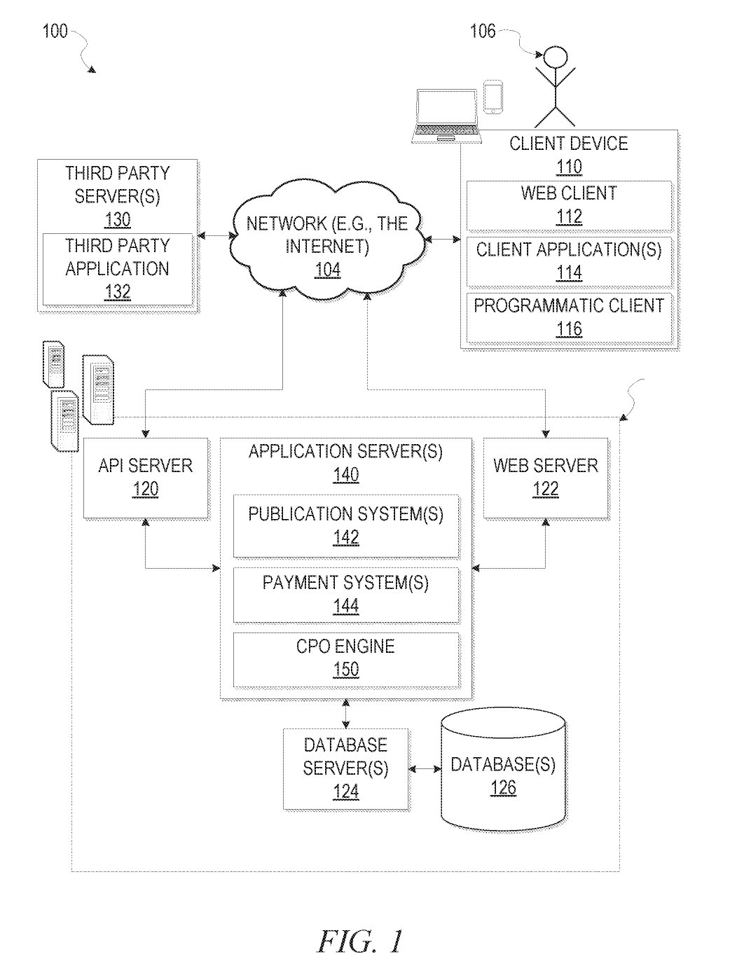

With reference to FIG. 1, an example embodiment of a high-level client-server-based network architecture 100 is shown. A networked system 102, in the example forms of a network-based marketplace or payment system, provides server-side functionality via a network 104 (e.g., the Internet or wide area network (WAN)) to one or more client devices 110. FIG. 1 illustrates, for example, a web client 112 (e.g., a browser, such as the Internet Explorer® browser developed by Microsoft® Corporation of Redmond, Wash. State), an application 114, and a programmatic client 116 executing on client device 110.

The client device 110 may comprise, but are not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may utilize to access the networked system 102. In some embodiments, the client device 110 may comprise a display module (not shown) to display information (e.g., in the form of user interfaces). In further embodiments, the client device 110 may comprise one or more of a touch screens, accelerometers, gyroscopes, cameras, microphones, global positioning system (GPS) devices, and so forth. The client device 110 may be a device of a user that is used to perform a transaction involving digital items within the networked system 102. In one embodiment, the networked system 102 is a network-based marketplace that responds to requests for product listings, publishes publications comprising item listings of products available on the network-based marketplace, and manages payments for these marketplace transactions. One or more users 106 may be a person, a machine, or other means of interacting with client device 110. In embodiments, the user 106 is not part of the network architecture 100, but may interact with the network architecture 100 via client device 110 or another means. For example, one or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each of the client device 110 may include one or more applications (also referred to as “apps”) such as, but not limited to, a web browser, messaging application, electronic mail (email) application, an e-commerce site application (also referred to as a marketplace application), and the like. In some embodiments, if the e-commerce site application is included in a given one of the client device 110, then this application is configured to locally provide the user interface and at least some of the functionalities with the application configured to communicate with the networked system 102, on an as needed basis, for data and/or processing capabilities not locally available (e.g., access to a database of items available for sale, to authenticate a user, to verify a method of payment, etc.). Conversely if the e-commerce site application is not included in the client device 110, the client device 110 may use its web browser to access the e-commerce site (or a variant thereof) hosted on the networked system 102.

One or more users 106 may be a person, a machine, or other means of interacting with the client device 110. In example embodiments, the user 106 is not part of the network architecture 100, but may interact with the network architecture 100 via the client device 110 or other means. For instance, the user provides input (e.g., touch screen input or alphanumeric input) to the client device 110 and the input is communicated to the networked system 102 via the network 104. In this instance, the networked system 102, in response to receiving the input from the user, communicates information to the client device 110 via the network 104 to be presented to the user. In this way, the user can interact with the networked system 102 using the client device 110.

An application program interface (API) server 120 and a web server 122 are coupled to, and provide programmatic and web interfaces respectively to, one or more application servers 140. The application servers 140 may host one or more publication systems 142 and payment systems 144, each of which may comprise one or more modules or applications and each of which may be embodied as hardware, software, firmware, or any combination thereof. The application servers 140 are, in turn, shown to be coupled to one or more database servers 124 that facilitate access to one or more information storage repositories or database(s) 126. In an example embodiment, the databases 126 are storage devices that store information to be posted (e.g., publications or listings) to the publication system 120. The databases 126 may also store digital item information in accordance with example embodiments.

Additionally, a third party application 132, executing on third party server(s) 130, is shown as having programmatic access to the networked system 102 via the programmatic interface provided by the API server 120. For example, the third party application 132, utilizing information retrieved from the networked system 102, supports one or more features or functions on a website hosted by the third party. The third party website, for example, provides one or more promotional, marketplace, or payment functions that are supported by the relevant applications of the networked system 102.

The publication systems 142 may provide a number of publication functions and services to users 106 that access the networked system 102. The payment systems 144 may likewise provide a number of functions to perform or facilitate payments and transactions. While the publication system 142 and payment system 144 are shown in FIG. 1 to both form part of the networked system 102, it will be appreciated that, in alternative embodiments, each system 142 and 144 may form part of a payment service that is separate and distinct from the networked system 102. In some embodiments, the payment systems 144 may form part of the publication system 142.

The CPO Engine 150 may provide functionality operable to perform various personalizations using the user selected data. For example, the personalization system 150 may access the user selected data from the databases 126, the third party servers 130, the publication system 120, and other sources. In some example embodiments, the personalization system 150 may analyze the user data to perform personalization of user preferences. As more content is added to a category by the user, the personalization system 150 can further refine the personalization. In some example embodiments, the personalization system 150 may communicate with the publication systems 120 (e.g., accessing item listings) and payment system 122. In an alternative embodiment, the personalization system 150 may be a part of the publication system 120.

Further, while the client-server-based network architecture 100 shown in FIG. 1 employs a client-server architecture, the present inventive subject matter is of course not limited to such an architecture, and could equally well find application in a distributed, or peer-to-peer, architecture system, for example. The various publication system 142, payment system 144, and personalization system 150 could also be implemented as standalone software programs, which do not necessarily have networking capabilities.

The web client 112 may access the various publication and payment systems 142 and 144 via the web interface supported by the web server 122. Similarly, the programmatic client 116 accesses the various services and functions provided by the publication and payment systems 142 and 144 via the programmatic interface provided by the API server 120. The programmatic client 116 may, for example, be a seller application (e.g., the Turbo Lister application developed by eBay® Inc., of San Jose, Calif.) to enable sellers to author and manage listings on the networked system 102 in an off-line manner, and to perform batch-mode communications between the programmatic client 116 and the networked system 102.

Additionally, a third party application(s) 128, executing on a third party server(s) 130, is shown as having programmatic access to the networked system 102 via the programmatic interface provided by the API server 114. For example, the third party application 128, utilizing information retrieved from the networked system 102, may support one or more features or functions on a website hosted by the third party. The third party website may, for example, provide one or more promotional, marketplace, or payment functions that are supported by the relevant applications of the networked system 102.

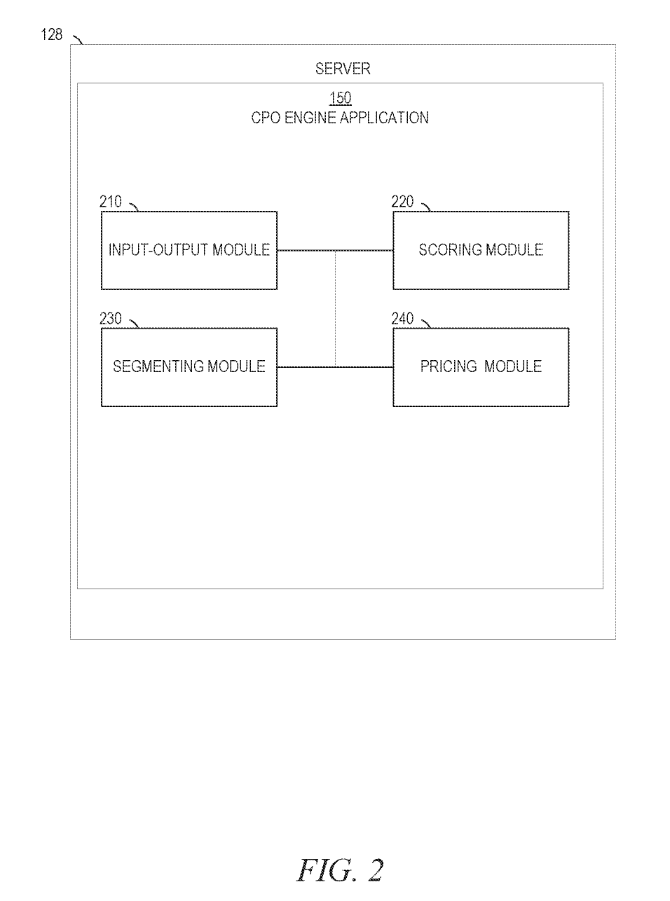

FIG. 2 is a block diagram illustrating components of an CPO Engine application 150, according to some example embodiments. The components communicate with each other to perform the operations of the CPO Engine. The CPO Engine application 150 is shown as including an input-output module 210, a scoring module 220, a segmenting module 230 and a pricing module 240, all configured to communicate with each other (e.g., via a bus, shared memory, or a switch).

Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The input-output module 210 is a hardware-implemented module which manages, controls, stores, and accesses information regarding inputs and outputs. An input can be an advertiser metric(s) and publisher data. An output can be a price (or adjusted priced) for serving online ads to one or more segments of accounts. An input can also be bids received from one or more 3^{rd} Party advertiser sources to serve online ads to one or more segments of accounts.

The scoring module 220 is a hardware-implemented module which manages, controls, stores, and accesses information regarding determining a score for a member account(s) based on fields from data packets received from at least one remote content provider and data from one or more member account data stores.

The segmenting module 230 is a hardware-implemented module which manages, controls, stores, and accesses information regarding determining segments of account based on their respective scores.

The pricing module 240 is a hardware-implemented module which manages, controls, stores, and accesses information for determining, for each segment of member accounts, a price for a future online content impression to be served to each member account within the corresponding segment.

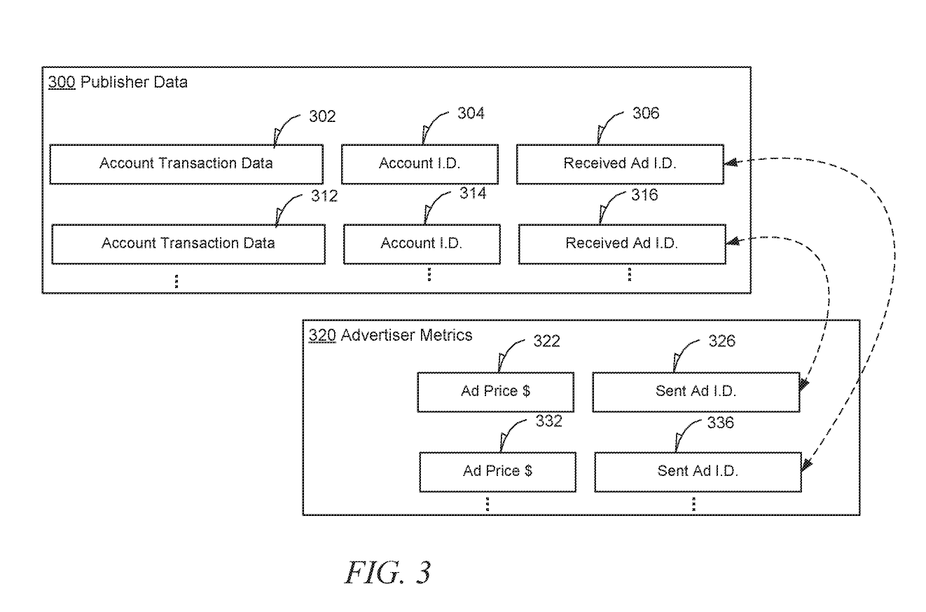

FIG. 3 is a block diagram of the CPO Engine 150 de-anonymizing advertiser metric data, according to some example embodiments. The publication system 142 includes one or more member account data stores which includes, for example, publisher data 300. Publisher data 300 includes publication system activity of a plurality of member accounts of the publication system 142. For example, the publication system 142 tracks content items received from remote content providers (such as online advertisements) that are displayed to each member account and tracks the transactions requested and completed by each member account—in order to create and store a purchase history for each member account.

According to an example embodiment, when a particular member account is logged into the publication system 142, the publication system 142 sends a request for an online advertisement to a 3^{rd} Party advertiser source. The CPO Engine 150 stores an account identifier for the particular member account in relation to the online advertisement that is served back for display to the particular member account. The CPO Engine 150 logs data for each member account as this occurs in the member account's data store—also referred herein as the publisher data 300.

The publisher data 300 thereby includes an account identifier 304, 314 for each member account to which content (such as, for example, an online advertisement) is displayed. In addition, the CPO Engine 150 stores an advertisement identifier 306, 316 for each online advertisement that is received and displayed. The CPO Engine 150 stores each advertisement identifier 306, 316 in relation to the account identifier 304, 314 of the respective member account to which the online advertisement was displayed. In addition, the publisher data 300 further includes member account purchase histories, such as transaction data 302, 312, stored in relation to the account identifiers 304, 314. The transaction data 302, 312 includes data regarding transactions completed by each respective member account, such as the purchase of one or more products, the cost of one or more purchased products and the timestamp of one or more transactions.

The CPO Engine 150 receives data packets (such as, for example, advertiser metrics 320) from a plurality of remote content providers (such as, for example, 3^{rd} Party advertiser sources). The advertiser metrics 302 include content item identifiers (such as advertisement identifiers 326, 336) that were sent to the publication system 142 for display to respective member accounts. The advertiser metrics 302 further includes an impression cost of each content item sent from the 3^{rd} Party advertiser sources. The impression cost are the prices 322, 332 paid by each 3^{rd} Party advertiser source to have the online advertisement displayed to a member account in the publication system 142. The advertiser metrics 320 is anonymous in that it does not explicitly identify which online advertisements were displayed to which member account.

To “de-anonymize” the advertiser metrics 320, the CPO Engine 150 identifies matches between a content field of a particular data packet and a received content item identifier in the corresponding member account's data store. For example, the CPO Engine 150 determines a match between a first sent advertisement identifier 326 and a first received advertisement identifier 316. Due to the match, the CPO Engine 150 identifies the impression cost of the particular data packet. Returning to the online advertisement example embodiment, the CPO Engine 150 determines the price 332 paid by a 3^{rd} Party advertiser source to advertise to the member account that corresponds with the second account identifier 304. The price 332 from the advertiser metrics 320 can used to create data that is be inserted into a content-pricing data structure for that member account, where the content-pricing data structure also includes that member account's purchase history. By “de-anonymizing” the advertiser metrics 320, the CPO Engine 150 can thereby calculate the average price paid for displaying online advertisements on a per-member account basis—as opposed to conventional systems.

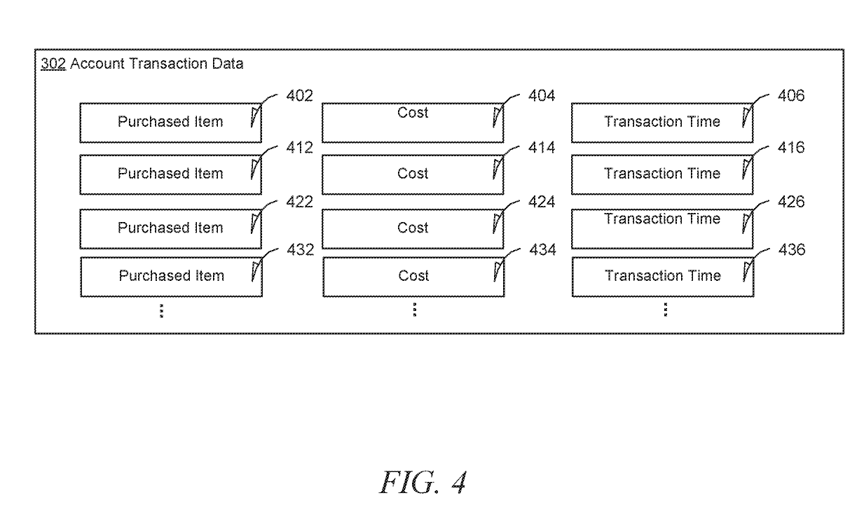

FIG. 4 is a block diagram illustrating account transaction data, according to some example embodiments. The member account data store for each member account includes the corresponding member account's purchase history. The purchase history is based in part on the member account's transaction data. The CPO Engine 150 logs transaction data for each member account of the publication system 142. As shown in FIG. 4, the CPO Engine 150 logs account transaction data 302 for a particular member account that corresponds with account identifier 304. The account transaction data 302 includes a description of each item 402, 412, 422, 432 . . . purchased by the particular member account and the respective cost 404, 414, 424, 434 . . . of each item 402, 412, 422, 432 . . . purchased by the particular member account. The account transaction data 302 further includes a transaction time 406, 416, 426, 436 . . . indicating a time (such as a day time stamp, hour time stamp, date time stamp) each particular member account purchased each item 402, 412, 422, 432 . . . . The CPO Engine 150 utilizes the account transaction data 302 to calculate a total amount of revenue generated from the particular member account that corresponds with account identifier 304. In the alternative, the CPO Engine 150 can further utilize a portion of the transaction times 406, 416, 426, 436 . . . to calculate an amount of revenue generated from the particular member account during a specific amount of time range.

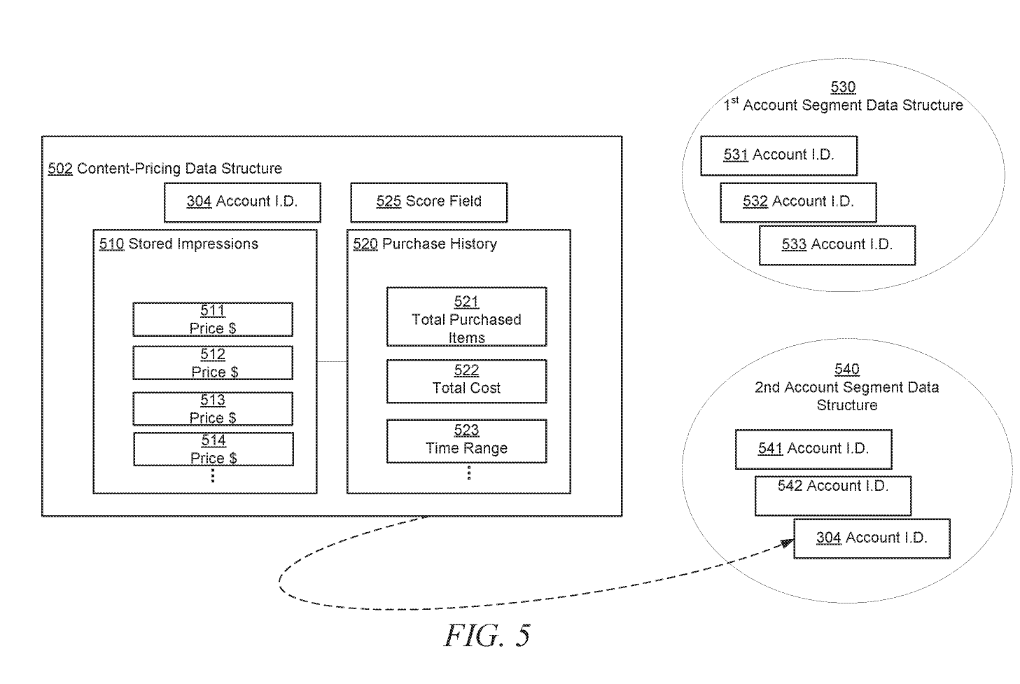

FIG. 5 is a block diagram of the CPO Engine 150 identifying a plurality of segment of member accounts, according to some example embodiments. In one embodiment, the CPO Engine 150 instantiates a plurality member account segment data structures. The CPO Engine 150 assigns a respective content-pricing score range for each member account data structure. The CPO Engine 150 accesses the content-pricing score data value of each member account. The CPO Engine 150 identifies which member account segment data structure has a content-pricing score range in which the accessed content-pricing score data value falls. The CPO Engine 150 inserts an identifier for the corresponding member account into the identified member account segment data structure.

Each member account segment data structure will ultimately include identifiers of member accounts that have content-pricing scores that fall within a particular content-pricing score range. For example, identifiers for member accounts with high content-pricing scores are inserted into a first member account segment data structure and identifiers for member accounts with lower content-pricing scores are inserted into a second member account segment data structure. The first member account segment data structure thereby represents a segment of highly-engaged users of the publication system 142 and the second member account segment data structure represents a segment of lesser-engaged users of the publication system 142.

Returning to the online advertisement example embodiment, based on the advertiser metrics 302 and each member account's transaction data 302, 312 . . . , the CPO Engine 150 identifies member account segment data structures (such as segments 530, 540 . . . ) based on each member account's content-pricing scores. In one embodiment, the content-pricing score can be based on the purchasing history of a particular member account and the average cost of presenting content (such as online advertisements) to the particular member account.

By instantiating each segment data structure 530, 540 . . . to sort member accounts 304, 531, 532, 533, 541, 542 . . . according to similar engagement levels, the CPO Engine 150 can auction the cost of presenting content (such as, for example, online advertising) to each segment 530, 540 . . . at different prices. In one embodiment, various 3^{rd} Party advertisement sources may be willing to pay a higher cost-per-advertisement impression to member accounts of a highly-engaged segment, since their respective publisher data scores show those highly-engaged member accounts tend to purchase many items or generate a lot of revenue. Advertising to these member accounts thereby provides more value to 3^{rd} Party advertisement entities than advertising to member accounts that have their identifiers placed in a less-engaged segment data structure.

In one embodiment, to calculate a content-price score for each member account, the CPO Engine 150 accesses, in the content-pricing data structure 502 for the corresponding member account, stored impressions 510 that includes each impression price 511, 512, 513, 514 . . . of any previously transmitted content item displayed to the corresponding member account 304. The CPO Engine 150 accesses, in the content-pricing data structure 502 for the corresponding member account 304, the stored purchase history 520 of the corresponding member account 304. The CPO Engine 150 calculates a content-pricing score for the corresponding member account 304 based on the each stored impression cost 511, 512, 513, 514 . . . and the stored at least portion of the purchase history 520. The CPO Engine 150 instantiates a content-pricing score data field 525 having an association with the corresponding member account 304 and the content-pricing data structure 502 for the corresponding member 304. The CPO Engine 150 inserts into the content-pricing score data field 525 the content-pricing score for the corresponding member account 304.

The CPO Engine 150 accesses the stored impressions 510 and the purchase history 520 in a content-pricing data structure 502 of member account to calculate a content-pricing score for that member account 304. The CPO Engine 150 calculates a content-pricing score by counting the amount of content impressions displayed to a member account each day during a time range. Each day has a particular day weight, where more recent days have a higher day weight. Each amount of content impressions for each day is multiplied by corresponding day weight to calculate impression-count-per-day output. All the impression-count-per-day outputs (for each day) are summed in order to generate an impression sum value.

The CPO Engine 150 calculates total revenue value based on all revenue represented in the purchase history 520 stored in the member account's content-pricing data structure 502. The corresponding member account's content-pricing score is based at least on a combination of the total revenue value and the impression sum value. In another embodiment, the CPO Engine 150 calculates total number of purchased products value represented in the purchase history stored in the member account's content-pricing data structure. The corresponding member account's content-pricing score is based at least on a combination of the total number of purchased products value and the impression sum value.

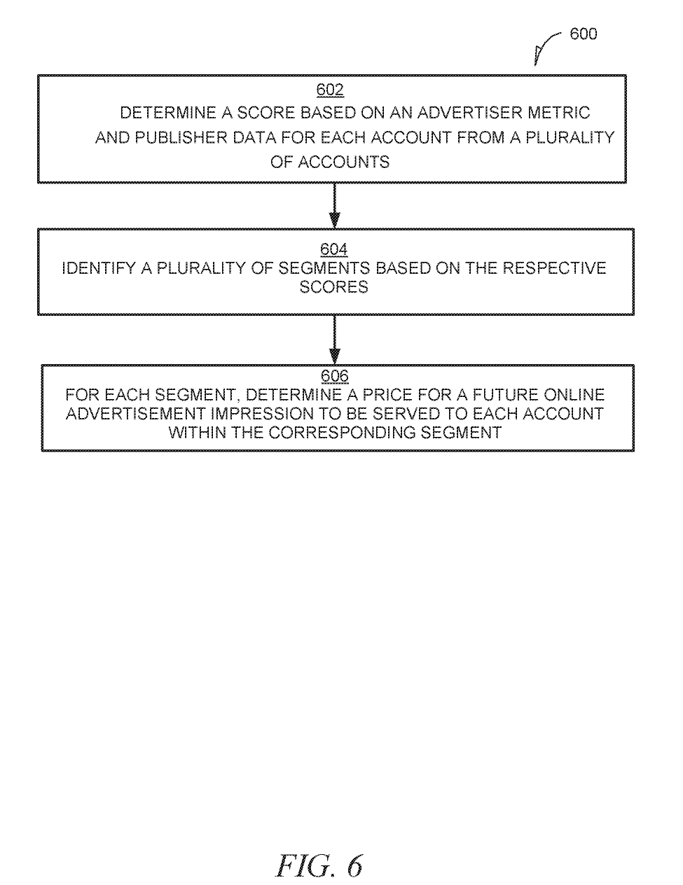

FIG. 6 is a flow diagram 600 illustrating an example of method operations for determining a price for a future online ad impression served to all accounts within respective segments, according to some example embodiments.

At operation 602, the CPO Engine 150 determines a score based on an advertiser metric and publisher data for each account from a plurality of accounts. An advertiser metric is received by the CPO Engine 150 from one or more 3^{rd} Party advertiser sources that serve online advertisements to the publication system 142. The advertiser metric describes various online advertisements that were served to the publication system 142 and displayed to various member accounts. In another example, the advertiser metric describes prices paid for one or more impressions of various online advertisements that were served to the publication system 142 and displayed to various member accounts. The CPO Engine 150 can thereby determine an average price-per-impression on a per-member account basis.

In an online advertising embodiment, the advertiser metric is anonymous in that it does not explicitly identify which online advertisement was served to which member account. However, when a call for an online advertisement is sent from the publication system 142 to a 3^{rd} Party advertiser source, the CPO Engine 150 stores an account identifier in relation to the online advertisement that is served back for display to that account. The CPO Engine 150 links the online advertisement(s) indicated in the advertiser metric with the appropriate member account based on the account's identifier stored at the time the call for that corresponding online advertisement was made. By leveraging stored member account identifiers, the CPO Engine 150 “de-anonymizes” the advertiser metric so as to identify each online advertisement displayed to each member account and the advertiser metric can be linked to publisher data on a per-account basis.

The CPO Engine 150 determines a score (such as a content-pricing score) for each member account based on the advertiser metric and publisher data. In one example, the advertiser metric includes a total amount of online advertisement impressions shown to a respective member account during a time range. The CPO Engine 150 applies various weighted coefficient(s) to more recently served online ad impressions, so as to place a higher significance of the impression costs of recent online advertisements than older previously online advertisements displayed to a member account. In another example, the advertiser metric is an average price paid per previous online ad impression shown to a respective member account during a time range. Again, CPO Engine 150 applies various weighted coefficient(s) to more recently served online advertisement impressions.

The publisher data is collected by the publication system 142. The publisher data indicates the browsing and purchasing behaviors for each respective member account. For example, the publisher data is a total amount of revenue the publication system 142 has generated from a respective member account during a time range. The CPO Engine 150 applies various weighted coefficient(s) to more recently generated portions of the revenue. In another example, the publisher data is a total amount of items the respective member account has purchased from the publication system 142 during a time range. The CPO Engine 150 applies various weighted coefficient(s) to more recently purchased items. Such weighted coefficients result in the score for an account to better reflect the member account's most recently viewed online advertisements and most recent purchasing behaviors.

Returning to the online advertising embodiment, to calculate an impression sum based on the advertiser metric, for a particular member account, the CPO Engine 150 calculates sum(day_score*impression_cnt)/(15*31). The “impression_cnt” variable represents a total number of online advertisement impressions for a given day. The “day_score” variable is decremented on a daily basis for days 30-1 in a 30 day time range. As such, the most recent day's “day_score” equals 30 and the next-most recent “day_score” equals 29, and so on.

To calculate a total purchased products value for the publisher data, for a particular member account, the CPO Engine 150 calculates a sum of the total amount items purchased by that particular member account during a time range (such as the most recent 30-day span). In another example, the CPO Engine 150 calculates a sum of the monetary revenue value of transactions by that particular member account during a time range. The CPO Engine 150 combines an advertiser metric score and the publisher data score of the particular account to calculate a total score for that particular member account. For example, the CPO Engine 150 multiplies or adds the impression sum with the total purchased products value or the revenue value.

At operation 604, the CPO Engine 150 identifies a plurality of segments based on the respective scores. The CPO Engine 150 collects the scores for each member account and identifies segments of member accounts based on their corresponding scores. For example, a first segment can include accounts having scores that are above the 90^{th} percentile of all scores. A second segment can include accounts having scores that are within the 89^{th} to 60^{th} percentile of all scores. A third segment can include accounts having scores that are within the 59^{th} to 40^{th} percentile of all scores. The CPO Engine 150 can further segment the member accounts based on their scores and one more attributes such as, for example, type of mobile device used, geographic location, age, gender, and/or the use of multiple computer device (i.e. cross-device users).

At operation 606, the CPO Engine 150 determines, for each segment, a price for a future online advertisement impression to be served to each account within the corresponding segment. In one example, the advertiser metric includes the prices paid for serving one or more online advertisements to various member accounts. The CPO Engine 150 calculates an average previous price of serving an online advertisement to one or more member accounts within a particular segment. The average price can be limited to a time range, such as the average price during the most recent week or month, etc. The CPO Engine 150 sets the auction price for serving online advertisements to all member accounts in that particular segment based on the average price. As actual bids are received (or not received), the CPO Engine 150 adjusts the auction price for the particular segment to better align with market demands.

In another example, an advertiser metric may not include the prices paid for serving one or more online advertisements to various member accounts in the particular segment. The CPO Engine 150 divides the particular segment into a control group of member accounts and a test group of accounts. The CPO Engine 150 calculates a first auction price for the control grouping based on an average of prices paid by 3^{rd} Party advertiser sources serving online ads throughout the publication system 142 and sets an auction price for serving ads to the control grouping to the average price. The CPO Engine 150 calculates a second auction price for the test grouping based on raising the first auction price according to a pre-defined amount (i.e. first auction price+$0.75). As actual bids are received (or not received) for both the control grouping and the test grouping, the CPO Engine 150 adjusts the first and second auction prices to better align with market demands.

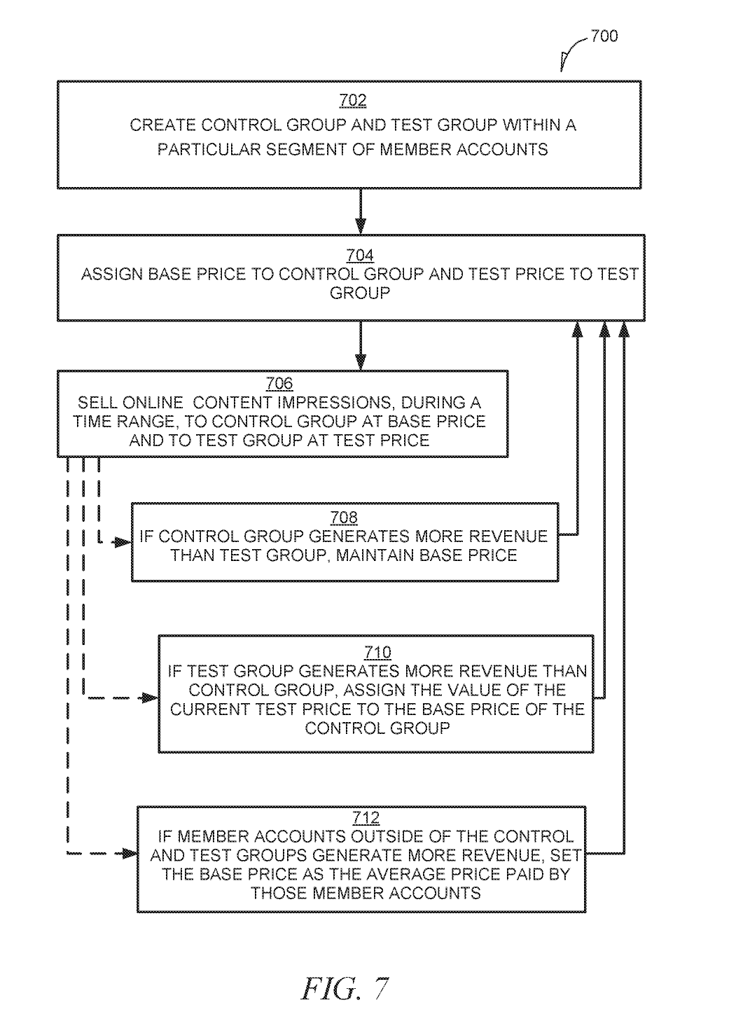

FIG. 7 is a flow diagram illustrating an example of method 700 operations for determining a price for displaying online content to each member account assigned to a particular segment of member accounts, according to some example embodiments.

At operation 702, the CPO Engine 150 creates a control group and a test group within a particular segment of member accounts. For example, the CPO Engine 150 randomly tags each member account identifier in a member account segment data structure with either a control group tag or a test group tag. In one embodiment, the CPO Engine 150 tags half of member account identifiers in the particular member account segment data structure with the control group tag and the other half of member accounts identifiers with the test group tag. In addition, the CPO Engine 150 identifies a plurality of member accounts of the publication system 142 that are not included in any segment. Such plurality of member account do not have their member account identifiers stored in any member account segment data structure. The plurality of member accounts are therefore outside the test group and control group and revenue data generated by transactional activity from the plurality of member accounts can be further utilized to adjust pricing of online content.

At operation 704, the CPO Engine 150 assigns a base price value to the control group and a test price value to the test group. For example, the base price value for the control group can be the average price during a previous time range for online content impressions to all member accounts identified in the particular member account segment data structure. The base price value thereby reflects the current “going rate” to present online content to the member accounts identified in the particular member account segment data structure. However, the base price value may actually be too high or too low in terms of the real-time market demand for displaying online content to these member accounts. To assess whether the base price value is accurate, the CPO Engine 150 instantiates the test price value for the test group. For example, the test price value is the base price value incremented according to some pre-defined amount (base price+X).

At operation 706, the CPO Engine 150 sells online content impressions, during a time range, to the control group at the base price and to the test group at the test price. For example, for a two week time period, the CPO Engine 150 sells impressions of online content to 3^{rd} Party content sources to the test group at the test price value and to the control group at the base price value. The time range is not limited to two weeks and can be, for example, any number of hours, days, weeks, months, years, etc.

At operation 708, the CPO Engine 150 maintains the base price if the control group generates the most revenue during the time range. For example, at the end of the two week time period, the CPO Engine 150 determines that the control group generated more revenue than the test group. Such a revenue result is an indication that the base price value better reflects an optimal price for selling online content impressions to all member accounts identified in the particular member account segment data structure. The CPO Engine 150 maintains the base price value and adjusts the test price value at operation 704. Upon returning to operation 704 from operation 708, the CPO Engine 150 adjusts the test price value according to base price+X₁, where X₁ is a result of incrementing or decrementing X. Stated differently, the CPO Engine 150 updates the test price value to be a different than the previous test price value.

In another embodiment, if the control group generates the most revenue during the two week time period, the CPO Engine 150 modifies the number of member accounts in the test group and returns to operation 704. Upon returning to operation 704 from operation 708 with a smaller test group, the CPO Engine 150 decrements the test price and maintains the base price.

At operation 710, the CPO Engine 150 assigns the value of the current test price to the base price if the test group generates the most revenue during the time range. For example, at the end of the two week time period, the CPO Engine 150 determines that the test group generated more revenue than the control group. Such a revenue result is an indication that the test price value better reflects an optimal price for selling online content impressions to all member accounts in the particular member account segment data structure. The CPO Engine 150 updates the base price value to be the current value of the test price value. The CPO Engine 150 returns to operation 704 from operation 710. When returning to operation 704 from operation 710, the CPO Engine 150 increments the test price to generate a new test price value. Stated differently, the base price value is updated to be the previous test price value and the CPO Engine 150 updates the test price value account to a pre-define amount.

At operation 712, the CPO Engine 150 sets the base price as the average price paid by member accounts outside the control group and test group if those member accounts generate more revenue than the control group and test group. In some cases, the plurality of member accounts outside the control group and test group may outperform the test group and control group in terms of revenue generation. Such a revenue result is an indication that both the test price and the base price fail to represent the optimal price for selling online advertisement impressions to all member accounts identified in the particular member account segment data structure. The CPO Engine 150 calculates an average price paid, during the two week time period, by 3^{rd} Party content sources for online content impressions to the plurality of member accounts outside the test and control groups. The CPO Engine 150 sets a new base price based on the average price and returns to operation 704. When returning to operation 704 from operation 712, the CPO Engine 150 sets a new test price based on incrementing or decrementing a pre-defined amount from the new base price.

In another embodiment, the CPO Engine 150 can implement a different approach for determining an optimal price for the particular segment of member accounts. The CPO Engine 150 identifies a time range (previous day, any number of previous days, previous weeks, previous months, etc.). The CPO Engine 150 calculates an average price paid by 3^{rd} Party content sources, during the time range, for displaying online content impressions to member accounts in the particular segment. The CPO Engine 150 identifies a plurality of member accounts of the publication system 142 that are not included in any segment. The CPO Engine 150 determines the revenue generated from displaying online content impressions, at a cost of the average price, to the particular segment of member accounts. The CPO Engine 150 determines the revenue generated from displaying online content impressions to the plurality of member accounts that are not included in any segment.

The CPO Engine 150 compares the revenue to determine whether the particular segment generated more revenue than the plurality of member accounts that are not included in any segment. If the particular segment generated more revenue, the CPO Engine 150 maintains the price for displaying online content impressions to the particular segment at the previously calculated average price. If the plurality of member accounts that are not included in any segment generated more revenue, the CPO Engine 150 calculates a new average price based on a new time range. Such a new time range would include the pricing data from the most recent days—which were not accounted for when the previous average price was calculated. However, if the plurality of member accounts that are not included in any segment continue to generate more revenue than the particular segment at the new average price, the CPO Engine 150 increments the new average price according to a pre-defined amount.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications and so forth described in conjunction with FIGS. 2-7 are implemented in some embodiments in the context of a machine and an associated software architecture. The sections below describe representative software architecture(s) and machine (e.g., hardware) architecture that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things.” While yet another combination produces a server computer for use within a cloud computing architecture. Not all combinations of such software and hardware architectures are presented here as those of skill in the art can readily understand how to implement the invention in different contexts from the disclosure contained herein.

### Software Architecture

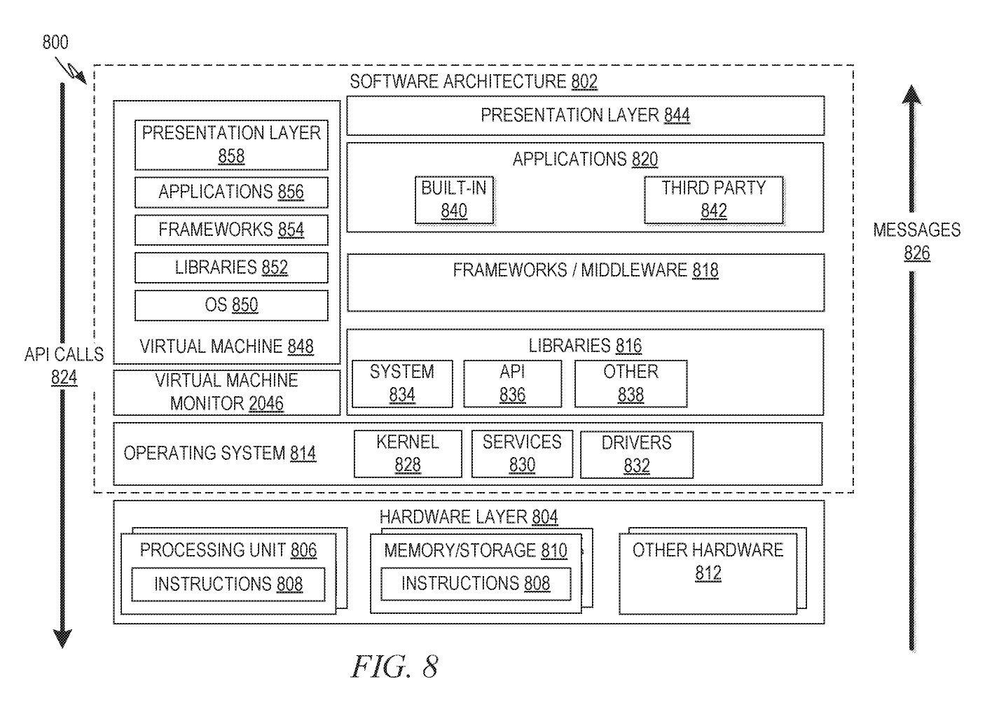

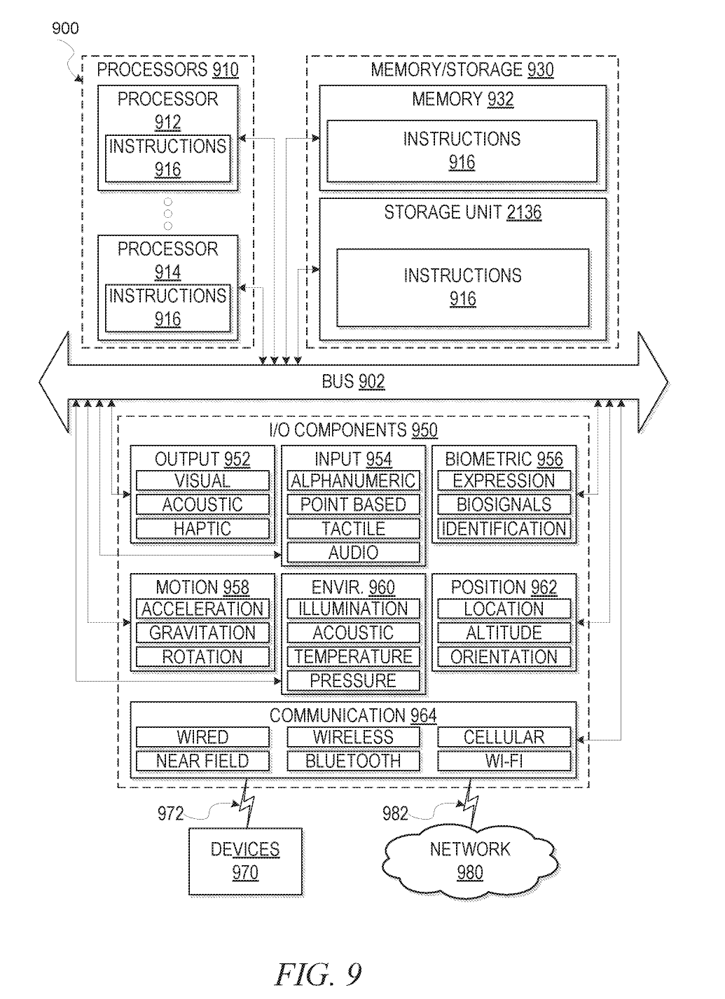

FIG. 8 is a block diagram 800 illustrating a representative software architecture 802, which may be used in conjunction with various hardware architectures herein described. FIG. 8 is merely a non-limiting example of a software architecture and it will be appreciated that many other architectures may be implemented to facilitate the functionality described herein. The software architecture 802 may be executing on hardware such as machine 900 of FIG. 9 that includes, among other things, processors 910, memory 930, and I/O components 950. A representative hardware layer 804 is illustrated and can represent, for example, the machine 900 of FIG. 9. The representative hardware layer 804 comprises one or more processing units 806 having associated executable instructions 808. Executable instructions 808 represent the executable instructions of the software architecture 802, including implementation of the methods, modules and so forth of FIGS. 2-7. Hardware layer 804 also includes memory and/or storage modules 810, which also have executable instructions 808. Hardware layer 804 may also comprise other hardware as indicated by 812 which represents any other hardware of the hardware layer 804, such as the other hardware illustrated as part of machine 900.

In the example architecture of FIG. 8, the software 802 may be conceptualized as a stack of layers where each layer provides particular functionality. For example, the software 802 may include layers such as an operating system 814, libraries 816, frameworks/middleware 818, applications 820 and presentation layer 844. Operationally, the applications 820 and/or other components within the layers may invoke application programming interface (API) calls 824 through the software stack and receive a response, returned values, and so forth illustrated as messages 826 in response to the API calls 824. The layers illustrated are representative in nature and not all software architectures have all layers. For example, some mobile or special purpose operating systems may not provide a frameworks/middleware layer 818, while others may provide such a layer. Other software architectures may include additional or different layers.

The operating system 814 may manage hardware resources and provide common services. The operating system 814 may include, for example, a kernel 828, services 830, and drivers 832. The kernel 828 may act as an abstraction layer between the hardware and the other software layers. For example, the kernel 828 may be responsible for memory management, processor management (e.g., scheduling), component management, networking, security settings, and so on. The services 830 may provide other common services for the other software layers. The drivers 832 may be responsible for controlling or interfacing with the underlying hardware. For instance, the drivers 832 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 816 may provide a common infrastructure that may be utilized by the applications 820 and/or other components and/or layers. The libraries 816 typically provide functionality that allows other software modules to perform tasks in an easier fashion than to interface directly with the underlying operating system 814 functionality (e.g., kernel 828, services 830 and/or drivers 832). The libraries 816 may include system 834 libraries (e.g., C standard library) that may provide functions such as memory allocation functions, string manipulation functions, mathematic functions, and the like. In addition, the libraries 816 may include API libraries 836 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 816 may also include a wide variety of other libraries 838 to provide many other APIs to the applications 820 and other software components/modules.

The frameworks 818 (also sometimes referred to as middleware) may provide a higher-level common infrastructure that may be utilized by the applications 820 and/or other software components/modules. For example, the frameworks 818 may provide various graphic user interface (GUI) functions, high-level resource management, high-level location services, and so forth. The frameworks 818 may provide a broad spectrum of other APIs that may be utilized by the applications 820 and/or other software components/modules, some of which may be specific to a particular operating system or platform.

The applications 820 includes built-in applications 840 and/or third party applications 842. Examples of representative built-in applications 840 may include, but are not limited to, a contacts application, a browser application, a book reader application, a location application, a media application, a messaging application, and/or a game application. Third party applications 842 may include any of the built in applications as well as a broad assortment of other applications. In a specific example, the third party application 842 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 842 may invoke the API calls 824 provided by the mobile operating system such as operating system 814 to facilitate functionality described herein.

The applications 820 may utilize built in operating system functions (e.g., kernel 828, services 830 and/or drivers 832), libraries (e.g., system 834, APIs 836, and other libraries 838), frameworks/middleware 818 to create user interfaces to interact with users of the system. Alternatively, or additionally, in some systems interactions with a user may occur through a presentation layer, such as presentation layer 844. In these systems, the application/module “logic” can be separated from the aspects of the application/module that interact with a user.

Some software architectures utilize virtual machines. In the example of FIG. 8, this is illustrated by virtual machine 848. A virtual machine creates a software environment where applications/modules can execute as if they were executing on a hardware machine (such as the machine of FIG. 9, for example). A virtual machine is hosted by a host operating system (operating system 814 in FIG. 9) and typically, although not always, has a virtual machine monitor 846, which manages the operation of the virtual machine as well as the interface with the host operating system (i.e., operating system 814). A software architecture executes within the virtual machine such as an operating system 850, libraries 852, frameworks/middleware 854, applications 856 and/or presentation layer 858. These layers of software architecture executing within the virtual machine 848 can be the same as corresponding layers previously described or may be different.

### Example Machine Architecture and Machine-Readable Medium

FIG. 9 is a block diagram illustrating components of a machine 900, according to some example embodiments, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. For example the instructions may cause the machine to execute the flow diagrams of FIGS. 6-7. Additionally, or alternatively, the instructions may implement the modules, operations, data structures and/or actions described of FIGS. 2-5, and so forth. The instructions transform the general, non-programmed machine into a particular machine programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory 930, and I/O components 950, which may be configured to communicate with each other such as via a bus 902. In an example embodiment, the processors 910 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 912 and processor 914 that may execute instructions 916. The term “processor” is intended to include multi-core processor that may comprise two or more independent processors (sometimes referred to as “cores”) that may execute instructions contemporaneously. Although FIG. 9 shows multiple processors, the machine 900 may include a single processor with a single core, a single processor with multiple cores (e.g., a multi-core process), multiple processors with a single core, multiple processors with multiples cores, or any combination thereof.

The memory/storage 930 may include a memory 932, such as a main memory, or other memory storage, and a storage unit 936, both accessible to the processors 910 such as via the bus 902. The storage unit 936 and memory 932 store the instructions 916 embodying any one or more of the methodologies or functions described herein. The instructions 916 may also reside, completely or partially, within the memory 932, within the storage unit 936, within at least one of the processors 910 (e.g., within the processor's cache memory), or any suitable combination thereof, during execution thereof by the machine 900. Accordingly, the memory 932, the storage unit 936, and the memory of processors 910 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 916. The term “machine-readable medium” shall also be taken to include any medium, or combination of multiple media, that is capable of storing instructions (e.g., instructions 916) for execution by a machine (e.g., machine 900), such that the instructions, when executed by one or more processors of the machine 900 (e.g., processors 910), cause the machine 900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 950 may include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion and the grouping is in no way limiting. In various example embodiments, the I/O components 950 may include output components 952 and input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 950 may include biometric components 956, motion components 958, environmental components 960, or position components 962 among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 962 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via coupling 982 and coupling 972 respectively. For example, the communication components 964 may include a network interface component or other suitable device to interface with the network 980. In further examples, communication components 964 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 970 may be another machine or any of a wide variety of peripheral devices (e.g., a peripheral device coupled via a Universal Serial Bus (USB)).

Moreover, the communication components 964 may detect identifiers or include components operable to detect identifiers. For example, the communication components 964 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 964, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 980 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network and the coupling 982 may be a Code Division Multiple Access (CDMA) connection, a Global System for Mobile communications (GSM) connection, or other type of cellular or wireless coupling. In this example, the coupling 982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., hypertext transfer protocol (HTTP)). Similarly, the instructions 916 may be transmitted or received using a transmission medium via the coupling 972 (e.g., a peer-to-peer coupling) to devices 970. The term “transmission medium” shall be taken to include any intangible medium that is capable of storing, encoding, or carrying instructions 916 for execution by the machine 900, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A computer system comprising:
a processor;
a memory device holding an instruction set executable on the processor to cause the computer system to perform operations comprising:
receiving a plurality of data packets from at least one remote content provider, wherein each of the data packets includes a content field identifying a previously transmitted content item and a price field identifying an impression cost of the previously transmitted content item;
for each member account of a plurality of member accounts:
accessing an member account data store, wherein the member account data store includes a purchase history of a corresponding member account and a plurality of received content item identifiers, wherein each received content item identifier indicates a respective content item from the at least one remote content provider displayed to the corresponding member account; and
instantiating a content-pricing data structure for the corresponding member account to include a linkage between the purchase history of the corresponding member account and each impression cost of any previously transmitted content item displayed to the corresponding member account.

2. The computer system of claim 1, wherein instantiating a content-pricing data structure for the corresponding member account to include a linkage between the purchase history of the corresponding member account and each impression cost of any previously transmitted content item displayed to the corresponding member account comprises:
identifying at least one match between a content field of a particular data packet and a received content item identifier in the corresponding member account's member account data store; and
de-anonymizing the impression cost of the particular data packet based on the at least one match with the received content item identifier in the corresponding member account's member account data store.

3. The computer system of claim 2, wherein de-anonymizing the impression cost of the particular data packet based on the at least one match with the received content item identifier in the corresponding member account's member account data store comprises:
due to the at least one match:
inserting the impression cost of the particular data packet into the content-pricing data structure for the corresponding member account; and
inserting at least a portion of the purchase history of the corresponding member account into the content-pricing data structure for the corresponding member account.

4. The computer system of claim 3, further comprising:
for each member account of a plurality of member accounts:
accessing, in the content-pricing data structure for the corresponding member account, each stored impression cost of any previously transmitted content item displayed to the corresponding member account;
accessing, in the content-pricing data structure for the corresponding member account, the stored at least portion of the purchase history of the corresponding member account;
calculating a content-pricing score for the corresponding member account based on the each stored impression cost and the stored at least portion of the purchase history;
instantiating a content-pricing score data field having an association with the corresponding member account and the content-pricing data structure for the corresponding member; and
inserting into the content-pricing score data field the content-pricing score for the corresponding member account.

5. The computer system of claim 4, wherein calculating a content-pricing score for the corresponding member account based on the each stored impression cost and the stored at least portion of the purchase history comprises:
wherein each member account data store includes a respective day date occurring in a time range for each received content item identifier;
wherein each member account data store includes a total amount of revenue generated by the corresponding member account during the time range;
for each respective day date:
counting a number of stored impression costs that have the respective day date;
accessing a day weight data field that corresponds to the respective day date;
calculating an impression-count-per-day output by multiplying the number of stored impression costs that have the respective day date and a value in the day weight data field; and
inserting the impression-count-per-day output into an impression-count-per-day data field associated with the respective day date; and
generating an impression sum value based at least on all impression-count-per-day data fields of each respective day date occurring in the time range; and
inserting the impression sum value into an impression-count sum field associated with the corresponding member account.

6. The computer system of claim 5, wherein calculating a content-pricing score for each member account further comprises:
calculating a total revenue value, from the stored at least portion of the purchase history generated value, generated by the corresponding member account during the time range;
inserting the total revenue value into a total revenue value field associated with the corresponding member account; and
accessing the total revenue value field and the impression-count sum field to calculate the content pricing score based on the total revenue value and the impression sum value.

7. The computer system of claim 5, wherein calculating a content-pricing score for each member account further comprises:
calculating a total number of purchased products value, from the stored at least portion of the purchase history, by the corresponding member account during the time range;
inserting the total number of purchased products value into a total products field associated with the corresponding member account; and
accessing the total products field and the impression-count sum field to calculate the content pricing score based on the total number of purchased products value and the impression sum value.

8. The computer system of claim 4, further comprising:
instantiating a plurality member account segment data structures;
assigning a respective content-pricing score range for each member account data structure;
for each member account of a plurality of member accounts:
accessing the content-pricing score data field of the corresponding member account to obtain the content-pricing score data value;
identifying the obtained content-pricing score data value falls within a particular content-pricing score range requirement for a particular member account segment data structure, and
inserting an identifier for the corresponding member account into the particular member account segment data structure.

9. A computer-implemented method, comprising:
receiving a plurality of data packets from at least one remote content provider, wherein each of the data packets includes a content field identifying a previously transmitted content item and a price field identifying an impression cost of the previously transmitted content item;
for each member account of a plurality of member accounts:
accessing an member account data store, wherein the member account data store includes a purchase history of a corresponding member account and a plurality of received content item identifiers, wherein each received content item identifier indicates a respective content item from the at least one remote content provider displayed to the corresponding member account; and
instantiating, via at least on processor, a content-pricing data structure for the corresponding member account to include a linkage between the purchase history of the corresponding member account and each impression cost of any previously transmitted content item displayed to the corresponding member account.

10. The computer-implemented method of claim 9, wherein instantiating a content-pricing data structure for the corresponding member account to include a linkage between the purchase history of the corresponding member account and each impression cost of any previously transmitted content item displayed to the corresponding member account comprises:
identifying at least one match between a content field of a particular data packet and a received content item identifier in the corresponding member account's member account data store; and
de-anonymizing the impression cost of the particular data packet based on the at least one match with the received content item identifier in the corresponding member account's member account data store.

11. The computer-implemented method of claim 10, wherein de-anonymizing the impression cost of the particular data packet based on the at least one match with the received content item identifier in the corresponding member account's member account data store comprises:
due to the at least one match:
inserting the impression cost of the particular data packet into the content-pricing data structure for the corresponding member account; and
inserting at least a portion of the purchase history of the corresponding member account into the content-pricing data structure for the corresponding member account.

12. The computer-implemented method of claim 11, further comprising:
for each member account of a plurality of member accounts:
accessing, in the content-pricing data structure for the corresponding member account, each stored impression cost of any previously transmitted content item displayed to the corresponding member account;
accessing, in the content-pricing data structure for the corresponding member account, the stored at least portion of the purchase history of the corresponding member account;
calculating a content-pricing score for the corresponding member account based on the each stored impression cost and the stored at least portion of the purchase history;
instantiating a content-pricing score data field having an association with the corresponding member account and the content-pricing data structure for the corresponding member; and
inserting into the content-pricing score data field the content-pricing score for the corresponding member account.

13. The computer-implemented method of claim 12, wherein calculating a content-pricing score for the corresponding member account based on the each stored impression cost and the stored at least portion of the purchase history comprises:
wherein each member account data store includes a respective day date occurring in a time range for each received content item identifier;
wherein each member account data store includes a total amount of revenue generated by the corresponding member account during the time range;
for each respective day date:
counting a number of stored impression costs that have the respective day date;
accessing a day weight data field that corresponds to the respective day date;
calculating an impression-count-per-day output by multiplying the number of stored impression costs that have the respective day date and a value in the day weight data field; and
inserting the impression-count-per-day output into an impression-count-per-day data field associated with the respective day date;
generating an impression sum value based at least on all impression-count-per-day data fields of each respective day date occurring in the time range; and
inserting the impression sum value into an impression-count sum field associated with the corresponding member account.

14. The computer-implemented method of claim 13, wherein calculating a content-pricing score for each member account further comprises:
calculating a total revenue value, from the stored at least portion of the purchase history generated value, generated by the corresponding member account during the time range;
inserting the total revenue value into a total revenue value field associated with the corresponding member account; and
accessing the total revenue value field and the impression-count sum field to calculate the content pricing score based on the total revenue value and the impression sum value.

15. The computer-implemented method of claim 13, wherein calculating a content-pricing score for each member account further comprises:
calculating a total number of purchased products value, from the stored at least portion of the purchase history, by the corresponding member account during the time range;
inserting the total number of purchased products value into a total products field associated with the corresponding member account; and
accessing the total products field and the impression-count sum field to calculate the content pricing score based on the total number of purchased products value and the impression sum value.

16. The computer-implemented method of claim 12, further comprising:
instantiating a plurality member account segment data structures;
assigning a respective content-pricing score range for each member account data structure;
for each member account of a plurality of member accounts:
accessing the content-pricing score data field of the corresponding member account to obtain the content-pricing score data value;
identifying the obtained content-pricing score data value falls within a particular content-pricing score range requirement for a particular member account segment data structure, and
inserting an identifier for the corresponding member account into the particular member account segment data structure.

17. A non-transitory computer-readable medium storing executable instructions thereon, which, when executed by a processor, cause the processor to perform operations including:
receiving a plurality of data packets from at least one remote content provider, wherein each of the data packets includes a content field identifying a previously transmitted content item and a price field identifying an impression cost of the previously transmitted content item;
for each member account of a plurality of member accounts:
accessing an member account data store, wherein the member account data store includes a purchase history of a corresponding member account and a plurality of received content item identifiers, wherein each received content item identifier indicates a respective content item from the at least one remote content provider displayed to the corresponding member account; and
instantiating a content-pricing data structure for the corresponding member account to include a linkage between the purchase history of the corresponding member account and each impression cost of any previously transmitted content item displayed to the corresponding member account.

18. The non-transitory computer-readable medium of claim 17, wherein instantiating a content-pricing data structure for the corresponding member account to include a linkage between the purchase history of the corresponding member account and each impression cost of any previously transmitted content item displayed to the corresponding member account comprises:
identifying at least one match between a content field of a particular data packet and a received content item identifier in the corresponding member account's member account data store; and
de-anonymizing the impression cost of the particular data packet based on the at least one match with the received content item identifier in the corresponding member account's member account data store.

19. The non-transitory computer-readable medium of claim 18, wherein de-anonymizing the impression cost of the particular data packet based on the at least one match with the received content item identifier in the corresponding member account's member account data store comprises:
due to the at least one match:
inserting the impression cost of the particular data packet into the content-pricing data structure for the corresponding member account; and
inserting at least a portion of the purchase history of the corresponding member account into the content-pricing data structure for the corresponding member account.

20. The non-transitory computer-readable medium of claim 19, further comprising:
for each member account of a plurality of member accounts:
accessing, in the content-pricing data structure for the corresponding member account, each stored impression cost of any previously transmitted content item displayed to the corresponding member account;
accessing, in the content-pricing data structure for the corresponding member account, the stored at least portion of the purchase history of the corresponding member account;
calculating a content-pricing score for the corresponding member account based on the each stored impression cost and the stored at least portion of the purchase history;
instantiating a content-pricing score data field having an association with the corresponding member account and the content-pricing data structure for the corresponding member; and
inserting into the content-pricing score data field the content-pricing score for the corresponding member account.
